(19) United States
(12) Patent Application Publication
(10) Pub. No.: US 2025/0039541 A1
(43) Pub. Date: Jan. 30, 2025

(54) QUICK START SYSTEM AND METHOD OF LOW POWER-CONSUMPTION NETWORK CAMERA

(71) Applicant: Hangzhou Meari Technology Co.,Ltd., Hangzhou (CN)

(72) Inventors: Huaqing Jiang, Hangzhou (CN); Wei Jin, Hangzhou (CN); Hongli Ying, Hangzhou (CN)

(21) Appl. No.: 18/782,406

(22) Filed: Jul. 24, 2024

(30) Foreign Application Priority Data
Jul. 25, 2023 (CN) 202310915908.4

(51) Int. Cl. H04N 23/65; H04N 23/60; H04N 23/61

(52) U.S. Cl. CPC H04N 23/651; H04N 23/61; H04N 23/64

(57) ABSTRACT

The present application provides a quick start system and method of a low power-consumption network camera. The quick start system comprises a main control module, and the main control module is connected to an image acquisition module, a sound acquisition module, a memory module, and a battery/power supply module, respectively; the image acquisition module and the sound acquisition module are used for acquiring a frame of image; the main control module is used for encoding the frame of image, storing the frame of image after being coded in the memory module, and intelligently detecting the frame of image; and the battery/power supply module is used for supplying power to the main control module, the image acquisition module, the sound acquisition module, and the memory module, and the main control module, the image acquisition module, and the sound acquisition module are repeatedly started according to a quick start time.

### CROSS-REFERENCE TO RELATED APPLICATIONS

This application claims priority to Chinese Patent Application No. 202310915908.4, filed on Jul. 25, 2023, which is hereby incorporated by reference in its entirety.

### TECHNICAL FIELD

The present invention belongs to the field of low power-consumption network cameras, and in particular relates to a quick start system and method of a low power-consumption network camera.

### BACKGROUND

The technical principle of existing low power-consumption cameras is to save power by hibernation. Through passive infrared (PIR) detection, when someone or an animal enters a surveillance region, the camera is awakened for video surveillance; and as a type of passive detection, PIR has an effective distance of less than 10 m, while the maximum visual range of surveillance exceeds 30 m, there may be a case that someone passes by but there is no video. Therefore, this type of technology is commonly used in an environment with a short detection distance such as a yard and a doorway, and is not suitable for a large-depth scene such as the wilds and farmland.

According to an existing disclosed camera and a method of controlling the camera (patent application number: CN202210870300.X), the camera comprises a sensor and a control chip, the sensor is operable in a low power-consumption mode to record a low-resolution image, and is operable in a non-low power-consumption mode to record a high-resolution image, and the control chip comprises: an always-on low power-consumption region comprising: a detection module for detecting the low-resolution image to determine whether a video recording triggering event occurs or not, wherein if the video recording triggering event occurs, the sensor is triggered to work in the non-low power-consumption mode and a non-low power-consumption region is trigger to be powered on; a compression module for compressing the low-resolution image; and a storage module for storing a compressed low-resolution image; and the non-low power-consumption region comprising: a decompression module for decompressing a stored low-resolution image; a super-resolution module for processing a decompressed low-resolution image to increase a resolution thereof; and a video packing module for compressing processed low-resolution images and high-resolution images and splicing the low-resolution images and the high-resolution images in a time sequence to obtain a video package.

This disclosed solution uses PIR passive triggering of a relatively simple technology, and this solution realizes the technology after detection occurs. Its energy saving is realized by dividing a system into a low power-consumption region and a non-low power-consumption region, continuously supplying power to the low power-consumption region, and triggering the non-low power-consumption mode at a key point, and a better energy-saving effect cannot be realized; and a detection distance of this solution is short, resulting in a problem of inoperable beyond the detection distance.

### SUMMARY

The present application provides a quick start system and method of a low power-consumption network camera, aiming to solve problems in the prior art that network cameras cannot realize a better low power-consumption effect, and are inoperable beyond the detection distance due to a short detection distance.

In order to realize the foregoing purpose, the following technical solution is adopted for the present invention:
a main control module is comprised, and the main control module is connected to an image acquisition module, a sound acquisition module, a memory module, and a battery/power supply module, respectively;
the image acquisition module and the sound acquisition module are used for acquiring a frame of image;
the main control module is used for encoding the frame of image, storing the frame of image after being coded in the memory module, and intelligently detecting the frame of image, to detect whether a suspicious target exists or not; and
the battery/power supply module is used for supplying power to the main control module, the image acquisition module, the sound acquisition module, and the memory module, and the main control module, the image acquisition module, and the sound acquisition module are repeatedly started according to a quick start time.

Preferably, the suspicious target comprises people, cars, animals, and fireworks.

Preferably, the quick start time ranges from 1 to 60 seconds.

Preferably, the main control module is further connected to a network module and a storage module, respectively;
the network module is used for remotely transmitting information, and the storage module is used for storing information, and when it is detected that the suspicious target exists in the frame of image or the network module receives a remote wake-up command or a storage space of the memory module is full, the image acquisition module and the sound acquisition module acquire continuous images;
the main control module encodes the continuous images and intelligently detects the continuous images, to detect whether the suspicious target exists or not;
the main control module encodes the continuous images, stores coded continuous images in the storage module, and transmits real-time continuous images through the network module; and
when no suspicious target exists in the continuous images or a timing time is up, the network module and the storage module hibernate, and the main control module, the image acquisition module, and the sound acquisition module are restarted according to the quick start time.

Preferably, the timing time is 10 seconds or 30 seconds or 60 seconds.

A quick start method of a low power-consumption network camera comprises:
powering on to reset the main control module the image acquisition module, and the sound acquisition module;
acquiring a frame of image through the image acquisition module and the sound acquisition module;
encoding the frame of image and storing a coded frame of image in a memory module through the main control module, and intelligently detecting the frame of image through the main control module, to detect whether a suspicious target exists or not;
configuring a quick start time; and
enabling the main control module, the image acquisition module, and the sound acquisition module to hibernate, and maintaining power supply to the memory module through the battery/power supply module.

Preferably, the method further comprises:
when it is detected that the suspicious target exists in the frame of image or a network module receives a remote wake-up command or a storage space of the memory module is full, enabling the network camera to enter a continuous workflow;
powering on to reset the main control module the image acquisition module, and the sound acquisition module;
powering on to reset the network module and a storage module;
acquiring continuous images through the image acquisition module and the sound acquisition module;
encoding the continuous images and intelligently detecting the continuous images through the main control module, to detect whether the suspicious target exists or not;
storing coded continuous images in the storage module through the main control module, and transmitting real-time continuous images through the network module; and
when no suspicious target exists in the continuous images or a timing time is up, reconfiguring the quick start time, enabling the network module and the storage module to hibernate, restarting the main control module, the image acquisition module, and the sound acquisition module according to the quick start time, maintaining power supply to the memory module, and enabling the network camera to enter a quick start workflow.

An electronic device comprises a memory and a processor, wherein the memory is used for storing one or more computer instructions, wherein the one or more computer instructions are executed by the processor to implement the quick start method of a low power-consumption network camera according to any one of the above.

A computer-readable storage medium is provided, wherein when a computer program is executed by a computer, the quick start method of a low power-consumption network camera according to any one of the above is implemented.

The present invention has the following beneficial effects:
(1) A manner of timed repeated start of encoding is adopted to realize power saving, and a timing range is from 1 s to 60 s. For example, the timing is 1 s, the camera quickly starts encoding (taking about 40 ms), and hibernates immediately after the encoding is completed. This execution is repeated in this way to realize 24-hour uninterrupted video recording (1 frame of video per second), and a power consumption of operation for 1 day is equivalent to a power consumption of continuous operation for 1 hour, thereby realizing long-term operation with an extremely low power consumption, and avoiding a case that no video is recorded due to a missed report upon 24-hour video recording, thus not only realizing a better low power-consumption effect, but also ensuring 24-hour uninterrupted continuous surveillance; and
(2) when being quickly started, the camera can also operate active video detection based on artificial intelligence, and record continuously after discovering human and animals, with higher detection accuracy, and a detection distance is up to 30 m, leading to a further effective detection distance, so that a problem that the existing network cameras are inoperable beyond the detection distance due to a short detection distance through passive infrared (PIR) detection is solved, and the camera is suitable for a large-depth scene such as the wilds and farmland, and has stronger applicability.

### BRIEF DESCRIPTION OF DRAWINGS

FIG. 1 is a schematic structural diagram of a quick start system of a low power-consumption network camera according to the present invention; and

FIG. 2 is a workflow chart of the low power-consumption network camera according to the present invention,

wherein 100-main control module, 101-image acquisition module, 102-sound acquisition module, 103-memory module, 104-network module, 105-storage module, 106-battery/power supply module.

### DETAILED DESCRIPTION OF THE EMBODIMENTS

### Embodiment 1

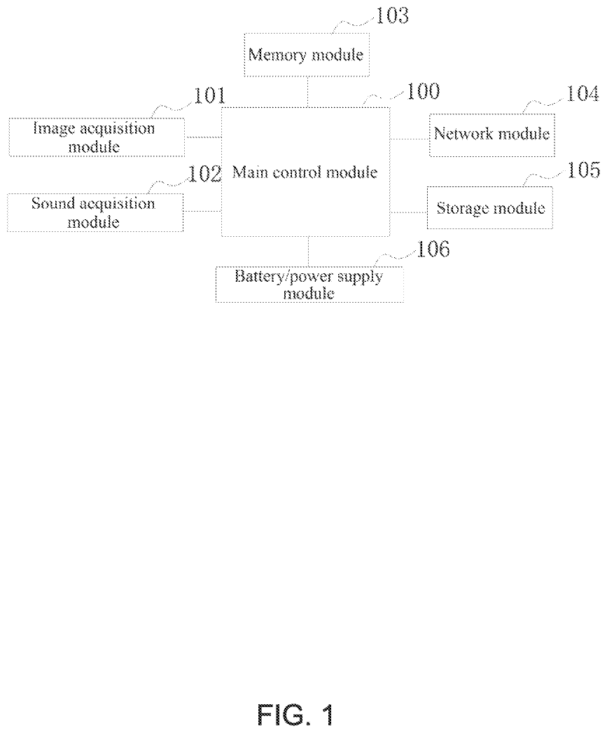

As shown in FIG. 1, a quick start system of a low power-consumption network camera comprises a main control module 100, and the main control module 100 is connected to an image acquisition module 101, a sound acquisition module 102, a memory module 103, and a battery/power supply module 106, respectively;
the image acquisition module 101 and the sound acquisition module 102 are used for acquiring a frame of image;
the main control module 100 is used for encoding the frame of image, storing the frame of image after being coded in the memory module 103, and intelligently detecting the frame of image, to detect whether a suspicious target exists or not; and the suspicious target comprises people, cars, animals, and fireworks.

A process of acquiring the frame of image and encoding and intelligent detection takes approximately 40 ms.

The battery/power supply module 106 is used for supplying power to the main control module 100, the image acquisition module 101, the sound acquisition module 102, and the memory module 103, and the main control module 100, the image acquisition module 101, and the sound acquisition module 102 are repeatedly started according to a quick start time.

The quick start time ranges from 1 to 60 seconds. When the quick start time is set to 1 s, the main control module 100, the image acquisition module 101, and the sound acquisition module 102 are powered on and restarted once for resetting every one second, and then enter into hibernation after operation for about 40 ms. This execution is repeated in this way to realize 24-hour uninterrupted video recording (1 frame of video per second), and a power consumption of operation for 1 day is equivalent to a power consumption of continuous operation for 1 hour, thereby realizing long-term operation with an extremely low power consumption.

The foregoing process is a quick start workflow of the network camera. The technology of quick start is described as follows: The memory module 103 maintains a power-on state, and only modules related to images and sound are started each time: the main control module 100, the image acquisition module 101, and the sound acquisition module 102; an image and sound are acquired, encoding of 1 frame of video and video image detection are completed, and the image is saved in the memory module 103 (for next quick start); after the saving is completed, other modules except the memory module 103 are powered off and hibernate; the memory module 103 maintains always-on, after being started, and the main control module 100 can continue to use the u-boot and kernel saved last time by the memory module 103, to realize a quick start; and the image is acquired through a quick start flow and H264/H265 encoding is performed.

The following process is a continuous workflow of the network camera:
The main control module 100 is further connected to a network module 104 and a storage module 105, respectively;
the network module 104 is used for remotely transmitting information, and the storage module 105 is used for storing information, and when it is detected that the suspicious target exists in the frame of image or the network module 104 receives a remote wake-up command or a storage space of the memory module 103 is full,
the image acquisition module 101 and the sound acquisition module 102 acquire continuous images; and the continuous images are 25 frames/second.

The main control module 100 encodes the continuous images and intelligently detects the continuous images, to detect whether the suspicious target exists or not;
the main control module 100 encodes the continuous images, stores coded continuous images in the storage module 105, and transmits real-time continuous images through the network module 104; and
when no suspicious target exists in the continuous images or a timing time is up, the network module 104 and the storage module 105 hibernate, and the main control module 100, the image acquisition module 101, and the sound acquisition module 102 are restarted according to the quick start time. The timing time may be 10 seconds or 30 seconds or 60 seconds. The settings are customized according to the needs of an actual scene.

Among them, there are three triggering situations in the continuous workflow, which respectively are: (1) the image is intelligently recognized based on deep learning for people, cars, animals, fireworks, etc. through the quick start process, and after the suspicious target is found, the camera can enter the continuous working mode (that may be configured for 10 seconds, 30 seconds, 60 seconds) to record more details; (2) when a video recording space configured in the memory module 103 reaches a threshold, the continuous working mode is started to save videos in the storage module 105; and (3) when the network module 104 receives a remote request, the continuous working mode is started, and real-time video data is transmitted.

The image detection technology is used in both the quick start workflow and the continuous workflow, thereby increasing the detection distance (30 m) and accuracy. Thus, the needs of users in large field scene without electricity are met, and the user experience is improved.

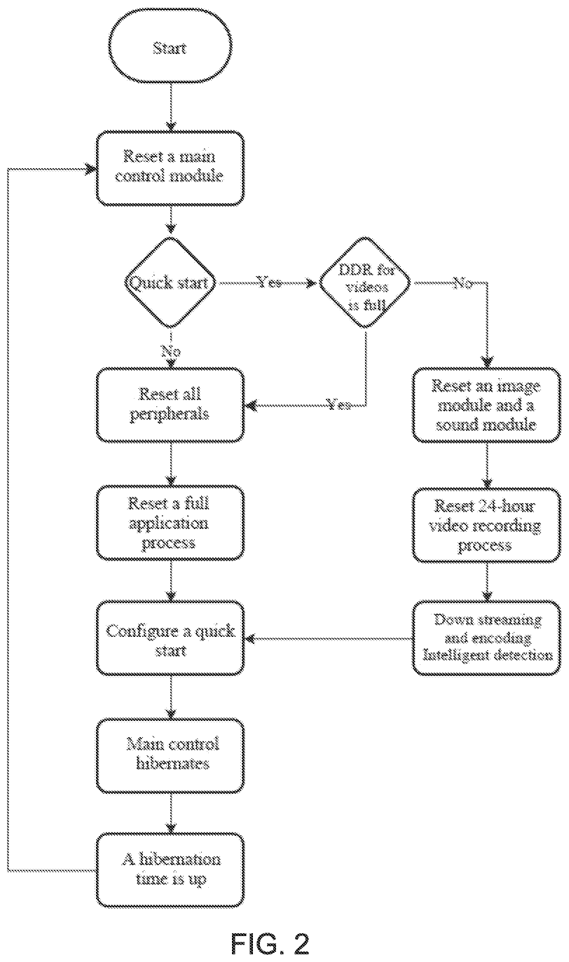

As shown in FIG. 2, specific workflows of this network camera (including the quick start workflow and the continuous workflow) are as follows:

The quick start workflow (as the right side of FIG. 2):
powering on to reset the main control module 100, the image acquisition module 101 and the sound acquisition module 102;
acquiring a frame of image through the image acquisition module 101 and the sound acquisition module 102;
encoding the frame of image and storing a coded frame of image in a memory module 103 through the main control module 100, and intelligently detecting the frame of image through the main control module 100, to detect whether a suspicious target exists or not;
configuring a quick start time; and
enabling the main control module 100, the image acquisition module 101, and the sound acquisition module 102 to hibernate, and maintaining power supply to the memory module 103 through the battery/power supply module 106.

The main control module 100, the image acquisition module 101, and the sound acquisition module 102 are restarted according to the quick start time, and a frame of image is acquired per second until 24-hour images are acquired. Through the foregoing quick start process, using 1/50 of the power consumption of normal operation, 1 frame of image can be acquired and saved in the memory, 24-hour recorded videos of 1 frame per second is obtained by repeating the process, and only 1/50 of the normal power consumption is required to realize continuous video recording with an extremely low power consumption.

The continuous workflow (as the left side of FIG. 2):
when it is detected that the suspicious target exists in the frame of image or a network module 104 receives a remote wake-up command or a storage space of the memory module 103 is full, enabling the network camera to enter a continuous workflow;
powering on to reset the main control module 100, the image acquisition module 101 and the sound acquisition module 102;
powering on to reset the network module 104 and a storage module 105;
acquiring continuous images through the image acquisition module 101 and the sound acquisition module 102;
encoding the continuous images and intelligently detecting the continuous images through the main control module 100, to detect whether the suspicious target exists or not;
storing coded continuous images in the storage module 105 through the main control module 100, and transmitting real-time continuous images through the network module 104; and
when no suspicious target exists in the continuous images or a timing time is up, reconfiguring the quick start time, enabling the network module 104 and the storage module 105 to hibernate, restarting the main control module 100, the image acquisition module 101, and the sound acquisition module 102 according to the quick start time, maintaining power supply to the memory module 103, and enabling the network camera to enter a quick start workflow.

The continuous working mode can realize real-time image transmission and saving and provide more video details.

### Embodiment 2

Based on the foregoing embodiments, this embodiment provides an electronic device.

### Embodiment 3

Based on the foregoing embodiments, this embodiment provides a storage medium.

The foregoing are only specific embodiments of the present invention, but the technical features of the present invention are not limited thereto. Any changes or modifications made by those skilled in the art within the field of the present invention shall fall within the patent scope of the present invention.

What is claimed is:

1. A quick start system of a low power-consumption network camera, comprising a main control module (100), wherein the main control module (100) is connected to an image acquisition module (101), a sound acquisition module (102), a memory module (103), and a battery/power supply module (106), respectively;
the image acquisition module (101) and the sound acquisition module (102) are used for acquiring a frame of image;
the main control module (100) is used for encoding the frame of image, storing the frame of image after being coded in the memory module (103), and intelligently detecting the frame of image, to detect whether a suspicious target exists or not; and
the battery/power supply module (106) is used for supplying power to the main control module (100), the image acquisition module (101), the sound acquisition module (102), and the memory module (103), and the main control module (100), the image acquisition module (101), and the sound acquisition module (102) are repeatedly started according to a quick start time.

2. The quick start system of a low power-consumption network camera according to claim 1, wherein the suspicious target comprises people, cars, animal, and fireworks.

3. The quick start system of a low power-consumption network camera according to claim 1, wherein the quick start time ranges from 1 to 60 seconds.

4. The quick start system of a low power-consumption network camera according to claim 1, wherein the main control module (100) is further connected to a network module (104) and a storage module (105), respectively;
the network module (104) is used for remotely transmitting information, the storage module (105) is used for storing information, and when it is detected that the suspicious target exists in the frame of image or the network module (104) receives a remote wake-up command or a storage space of the memory module (103) is full,
the image acquisition module (101) and the sound acquisition module (102) acquire continuous images;
the main control module (100) encodes the continuous images and intelligently detects the continuous images, to detect whether the suspicious target exists or not;
the main control module (100) encodes the continuous images, stores coded continuous images in the storage module (105), and transmits real-time continuous images through the network module (104); and
when no suspicious target exists in the continuous images or a timing time is up, the network module (104) and the storage module (105) hibernate, and the main control module (100), the image acquisition module (101), and the sound acquisition module (102) are restarted according to the quick start time.

5. The quick start system of a low power-consumption network camera according to claim 4, wherein the timing time is 10 seconds or 30 seconds or 60 seconds.

6. A quick start method of a low power-consumption network camera, comprising:
powering on to reset a main control module (100), an image acquisition module (101), and a sound acquisition module (102);
acquiring a frame of image through the image acquisition module (101) and the sound acquisition module (102);
encoding the frame of image and storing a coded image in a memory module (103) through the main control module (100), and intelligently detecting the frame of image through the main control module (100), to detect whether a suspicious target exists or not;
configuring a quick start time; and
enabling the main control module (100), the image acquisition module (101), and the sound acquisition module (102) to hibernate, and maintaining power supply to the memory module (103) through the battery/power supply module (106).

7. The quick start method of a low power-consumption network camera according to claim 6, further comprising:
when it is detected that the suspicious target exists in the frame of image or a network module (104) receives a remote wake-up command or a storage space of the memory module (103) is full, enabling the network camera to enter a continuous workflow;
powering on to reset a main control module (100), an image acquisition module (101), and a sound acquisition module (102);
powering on to reset the network module (104) and a storage module (105);
acquiring continuous images through the image acquisition module (101) and the sound acquisition module (102);
encoding the continuous images and intelligently detecting the continuous images through the main control module (100), to detect whether the suspicious target exists or not;
storing coded continuous images in the storage module (105) through the main control module (100), and transmitting real-time continuous images through the network module (104); and
when no suspicious target exists in the continuous images or a timing time is up, reconfiguring the quick start time, enabling the network module (104) and the storage module (105) to hibernate, restarting the main control module (100), the image acquisition module (101), and the sound acquisition module (102) according to the quick start time, maintaining power supply to the memory module (103), and enabling the network camera to enter a quick start workflow.

8. An electronic device, comprising a memory and a processor, wherein the memory is used for storing one or more computer instructions, wherein the one or more computer instructions are executed by the processor to implement the quick start method of a low power-consumption network camera according to claim 6.

9. A computer-readable storage medium, wherein when a computer program is executed by a computer, the quick start method of a low power-consumption network camera according to claim 6 is implemented.
